(19) United States
(12) Patent Application Publication
(10) Pub. No.: US 2021/0100179 A1
(43) Pub. Date: Apr. 8, 2021

(54) STACKABLE GROW-POT SYSTEM UTILIZING AQUAPONICS

(71) Applicant: Timothy Woolsey, Gilbert, AZ (US)

(72) Inventor: Timothy Woolsey, Gilbert, AZ (US)

(21) Appl. No.: 16/595,670

(22) Filed: Oct. 8, 2019

(51) Int. Cl. A01G 31/06

(52) U.S. Cl. CPC A01G 31/06; A01G 2031/006

(57) ABSTRACT

A stackable grow-pot system, including a plurality of pots stacked vertically with respect to one another such that one of the plurality of pots is a top-most pot and another one of the plurality of pots is a bottom-most pot, such that water flows from the top-most pot to the bottom-most pot via any other pots of the plurality of pots, a stabilizing pole to pass through center apertures of each of the plurality of pots to align the plurality of pots with respect to one another, and a plurality of auto-siphon tubes disposed singularly in each of the plurality of pots in various quadrants therein, to allow the water to flow between the pots.

### BACKGROUND

### 1. Field

The present general inventive concept relates generally to an improved stackable grow-pot system utilizing aquaponics.

### 2. Description of the Related Art

Aquaponics is the combination of aquaculture and hydroponics, whereby plants benefit from the waste products from fish and other aquatic animals. Existing stackable grow-pot systems do not provide for a controlled flow of water from one stack to the next, making it impossible for all layers in the system to be watered in an optimal fashion. Also, these existing systems allow inadequate spacing between layers thereby preventing the water from adequately re-oxygenating itself as it flows from one layer to the next, and also restricting the size of plants that may be grown in such a system.

Therefore, there is a need for an improved stackable grow-pot system utilizing aquaponics.

### SUMMARY

The present general inventive concept provides an improved stackable grow-pot system utilizing aquaponics.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a stackable grow-pot system, including a plurality of pots stacked vertically with respect to one another such that one of the plurality of pots is a top-most pot and another one of the plurality of pots is a bottom-most pot, such that water flows from the top-most pot to the bottom-most pot via any other pots of the plurality of pots, a stabilizing pole to pass through center apertures of each of the plurality of pots to align the plurality of pots with respect to one another, and a plurality of auto-siphon tubes disposed singularly in each of the plurality of pots in various quadrants therein, to allow the water to flow between the pots.

The stackable grow-pot system may further include a plurality of center walls disposed within each of the plurality of pots, and a plurality of wedges disposed between each of the plurality of center walls to allow the stabilizing pole to remain water-tight.

The stackable grow-pot system may further include a water collecting basin disposed at a bottom portion of the stackable grow-pot system to collect water drained from the plurality of pots.

The water collecting basin may include a water pump to allow the water to flow from the water collecting basin back into the top-most pot.

The stackable grow-pot system may further include a drain pipe disposed on the bottom-most pot to allow the water to flow from the bottom-most pot to the water collecting basin.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side angled perspective view of a stackable grow-pot system, according to an exemplary embodiment of the present general inventive concept;

FIG. 2 illustrates a side angled perspective view of a pot of the stackable grow-pot system, according to an exemplary embodiment of the present general inventive concept;

FIG. 3 illustrates a top view of a pot of the stackable grow-pot system, according to an exemplary embodiment of the present general inventive concept;

FIG. 4 illustrates a diagram illustrating details of components within the stackable grow-pot system, according to an exemplary embodiment of the present general inventive concept; and

FIG. 5 illustrates a diagram illustrating a flow of water within the stackable grow-pot system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

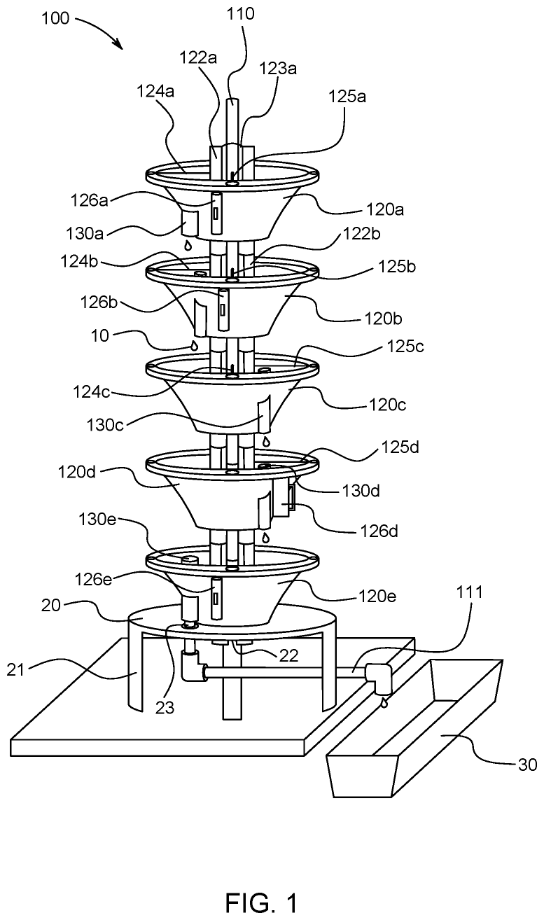

FIG. 1 illustrates a side angled perspective view of a stackable grow-pot system 100, according to an exemplary embodiment of the present general inventive concept.

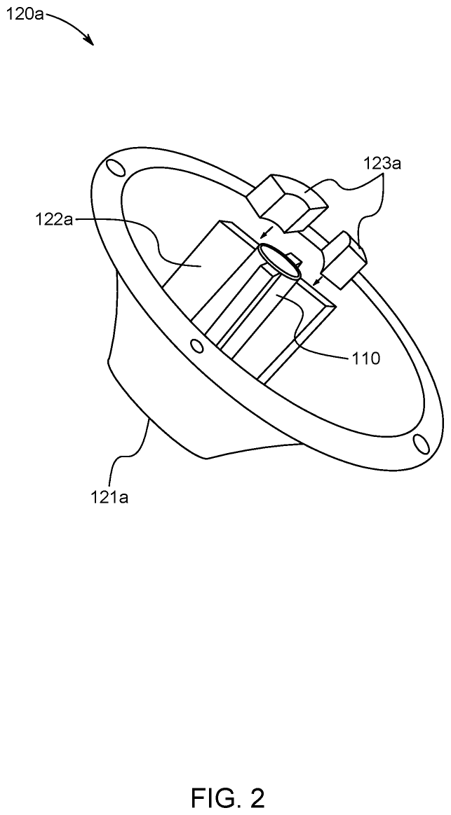

FIG. 2 illustrates a side angled perspective view of a pot of the stackable grow-pot system 100, according to an exemplary embodiment of the present general inventive concept.

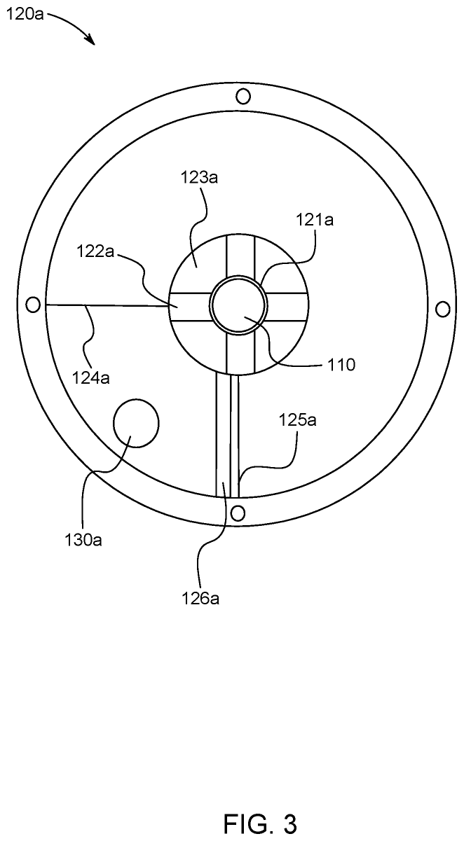

FIG. 3 illustrates a top view of a pot 120a of the stackable grow-pot system 100, according to an exemplary embodiment of the present general inventive concept.

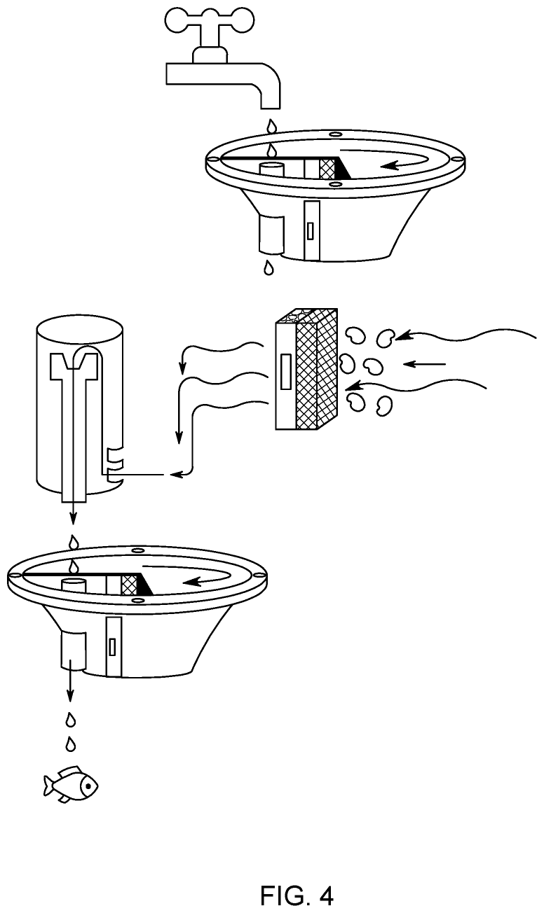

FIG. 4 illustrates a diagram illustrating details of components within the stackable grow-pot system 100, according to an exemplary embodiment of the present general inventive concept.

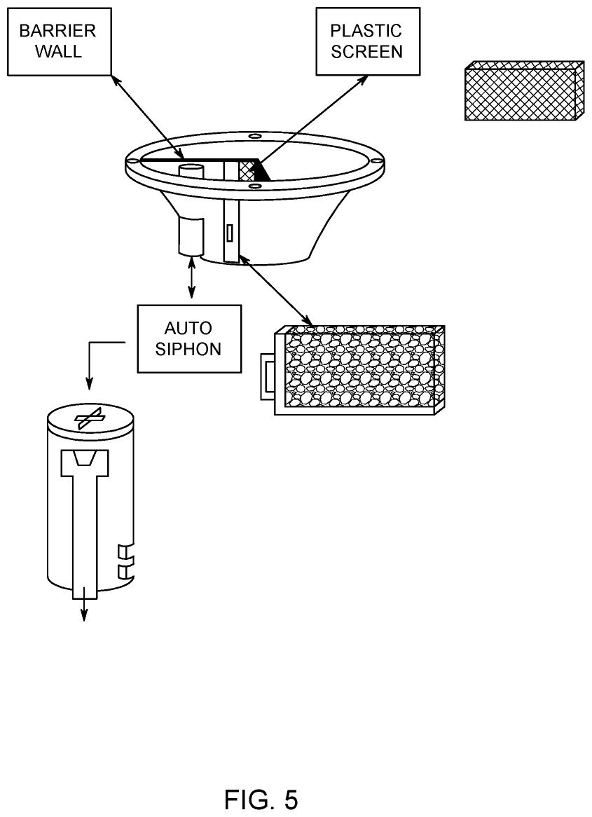

FIG. 5 illustrates a diagram illustrating a flow of water 10 within the stackable grow-pot system 100, according to an exemplary embodiment of the present general inventive concept.

Referring to FIGS. 1 through 5, the stackable grow-pot system 100 may include a stabilizing pole 110 and a plurality of pots 120a, 120b, 120c, 120d, and 120e stacked over one another, starting with the pot 120a disposed at a top portion of the stackable grow-pot system 100, and having the pot 120e on a bottom portion of the stackable grow-pot system 100.

The plurality of pots 120a, 120b, 120c, 120d, and 120e may have a circular and/or conical shape to facilitate an optimal flow of water 10 therein and therebetween, and the plurality of pots 120a, 120b, 120c, 120d, and 120e may stack on top of one another around the stabilizing pole 110, which may pass through a center aperture 121a, 121b, 121c, 121d, and 121e of each of the plurality of pots 120a, 120b, 120c, 120d, and 120e.

The stackable grow-pot system 100 provides for a controlled and predictable flow of the water 10 from one layer of the system to the next (i.e., water 10 may flow at a controlled and predictable rate from the pot 120a to the pot 120b to the pot 120c to the pot 120d to the pot 120e), while also providing adequate spacing between the each of the plurality of pots 120a, 120b, 120c, 120d, and 120e, so that the descending water 10 has time to properly re-oxygenate, and also allowing for growth of larger species of plants.

Although five pots 120a, 120b, 120c, 120d, and 120e are illustrated in FIG. 1, any number of pots may be included in the stackable grow-pot system 100.

The stackable grow-pot system 100 may use an electric water pump to draw the water 10 from a fish tank (or any other water source desired by a user), and send the water 10 via a supply tube to the pot 120a disposed at the top of the stackable grow-pot system 100 (though the fish tank itself is not part of the system being depicted here).

As stated above, disposed at center portions of a base of each of the plurality of pots 120a, 120b, 120c, 120d, and 120e is disposed the stabilizing pole 110, which is held in place by a plurality of center walls 122a, 122b, 122c, 122d, and 122e, disposed within each of the plurality of pots 120a, 120b, 120c, 120d, and 120e.

A plurality of wedges 123a, 123b, 123c, 123d, and 123e are disposed between each of the plurality of center walls 122a, 122b, 122c, 122d, and 122e to allow the stabilizing pole 110 to remain water-tight.

Each of the plurality of pots 120a, 120b, 120c, 120d, and 120e may also include a wall 124a, 124b, 124c, 124d, and 124e disposed therewithin, as well as screen walls 125a, 125b, 125c, 125d, and 125e disposed at another portion within each of the plurality of pots 120a, 120b, 120c, 120d, and 120e. The screen walls 125a, 125b, 125c, 125d, and 125e may prevent dirt and debris from entering an area partitioned by the walls 124a, 124b, 124c, 124d, and 124e and the screen walls 125a, 125b, 125c, 125d, and 125e.

A plurality of filters 126a, 126b, 126c, 126d, and 126e may be disposed next to the screen walls 125a, 125b, 125c, 125d, and 125e to provide extra filters for the plurality of pots 120a, 120b, 120c, 120d, and 120e.

The flow of the water 10 between each of the plurality of pots 120a, 120b, 120c, 120d, and 120e may be controlled by an auto-siphon/siphon tube 130a, 130b, 130c, 130d, and 130e. As stated above, one-quarter of each of the plurality of pots 120a, 120b, 120c, 120d, and 120e will be sectioned off for the auto-siphon/siphon tube 130a, 130b, 130c, 130d, and 130e, respectively, and the water 10 will flow into the siphon quadrants through a plastic screen and a removable filter sponge. The screen and filter will prevent growing media from clogging the siphon. This auto-siphon system 130 will ensure that the water keeps moving and stays fresh, while controlling the flow of water from one layer of the stack to the next.

The stackable grow-pot system 100 may be disposed on a stand 20 having a plurality of legs 21 and a pole receiving aperture 22 disposed at a center portion thereof to receive the stabilizing pole 110 therein, in order to provide stability for the stackable grow-pot system 100. The stand 20 may also include a drain pipe aperture 23 to receive a drain pipe 111 therein, which extends from a bottom of the pot 120e, and allows the water 10 to flow therefrom and through the drain pipe 111 into a water collecting basin 30.

The water collecting basin 30 may include a water pump to allow the water 10 to flow back into the pot 120a, such that the cycle of water re-usage continues.

The stackable grow-pot system 100 may be also called a “Tower,” and may incorporate anywhere from one to over one hundred layers (i.e., pots stacked upon each other). The stackable grow-pot system 100 has the potential to revolutionize the aquaponics industry, making it possible that this system will be readily available from garden supply centers and through online retailers.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A stackable grow-pot system, comprising:
a plurality of pots stacked vertically with respect to one another such that one of the plurality of pots is a top-most pot and another one of the plurality of pots is a bottom-most pot, such that water flows from the top-most pot to the bottom-most pot via any other pots of the plurality of pots;
a stabilizing pole to pass through center apertures of each of the plurality of pots to align the plurality of pots with respect to one another; and
a plurality of auto-siphon tubes disposed singularly in each of the plurality of pots in various quadrants therein, to allow the water to flow between the pots.

2. The stackable grow-pot system of claim 1, further comprising:
a plurality of center walls disposed within each of the plurality of pots; and
a plurality of wedges disposed between each of the plurality of center walls to allow the stabilizing pole to remain water-tight.

3. The stackable grow-pot system of claim 1, further comprising:
a water collecting basin disposed at a bottom portion of the stackable grow-pot system to collect water drained from the plurality of pots.

4. The stackable grow-pot system of claim 3, wherein the water collecting basin comprises:
a water pump to allow the water to flow from the water collecting basin back into the top-most pot.

5. The stackable grow-pot system of claim 3, further comprising:
a drain pipe disposed on the bottom-most pot to allow the water to flow from the bottom-most pot to the water collecting basin.
